(19) United States
(12) Patent Application Publication
(10) Pub. No.: US 2004/0025826 A1
(43) Pub. Date: Feb. 12, 2004

(54) Variable geometry engine, arranged from two identical internal combustion engines

(76) Inventor: Charles Reed Grosh SR., Eutawville, SC (US)

Correspondence Address: Charles R. Grosh, 155 Merideth Drive, Eutawville, SC, 29048, US

(21) Appl. No.: 10/215,055

(22) Filed: Aug. 8, 2002

(51) Int. Cl. F02B 75/32

(52) U.S. Cl. 123/197.1

(57) ABSTRACT

This invention enable a user to use two identical engines independently or to combine them with this specially designed gear box assembly into various configurations to satisfy users requirements for size, power, shape and firing sequence. This invention will provide the user with a smoother running engine and eliminates the power robbing torque by the unique application of the gear box assembly.

### CROSS-REFERENCE TO RELATED APPLICATIONS

Not Applicable

### FEDERALLY SPONSORED RESEARCH OR DEVELOPMENT

Not Applicable

### SEQUENCE LISTING, TABLE OR COMPUTER PROGRAM LISTING ON COMPACT DISC

Not Applicable

### BACKGROUND OF THE INVENTION

The idea first started in 1949 when there were no multi-cylinder model aircraft engines on the market. I purchased two identical model aircraft engines with the intent of joining them into a two cylinder engine. These are the same engines used in the designing of my prototype

The design and documentation was begun on Dec. 6, 2001. Final drawings were sent to a machine shop for fabrication on May 23, 2002.

The engine manufacturers are now producing multi-cylinder engines in various, but fixed configurations to meet individual requirements for shape, size and power of the item being powered.

### BRIEF SUMMARY OF THE INVENTION

My invention is a gearbox assembly which is used to join two internal combustion engines to create various changeable geometries without altering the original engine. By changing the alignment of the internal gears in the gearbox, the firing sequent of two engines can be changed to create a quieter, smoother running engine. The crankshafts of the two joined engines will rotate in opposite directions, bringing more advantages over standard engines.

### BRIEF DESCRIPTION OF DRAWINGS

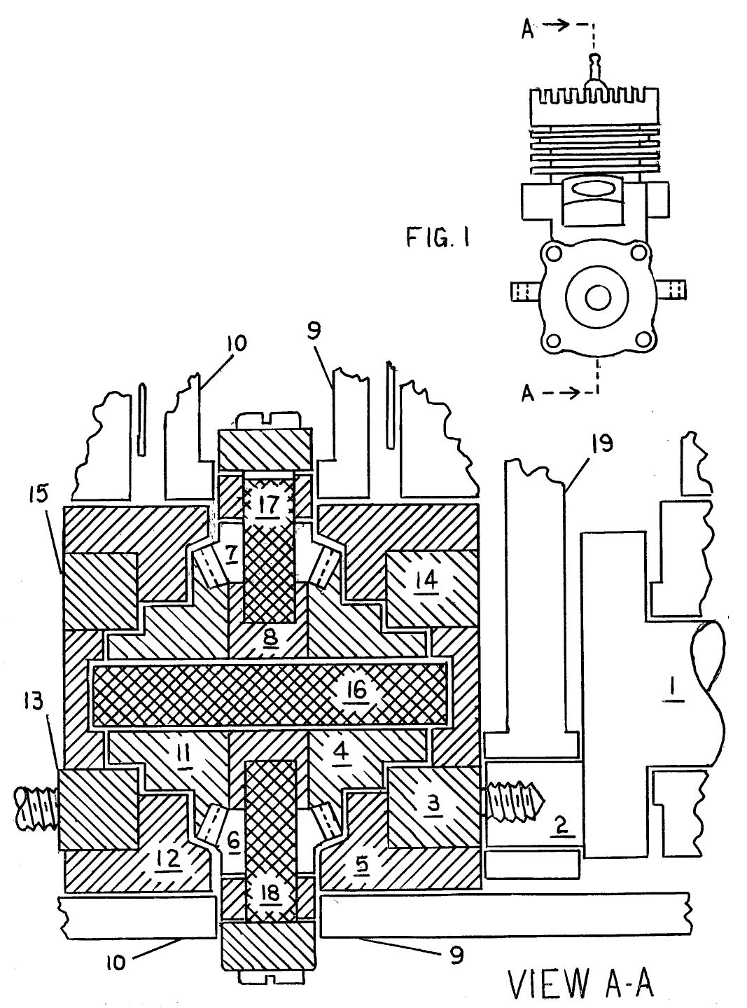

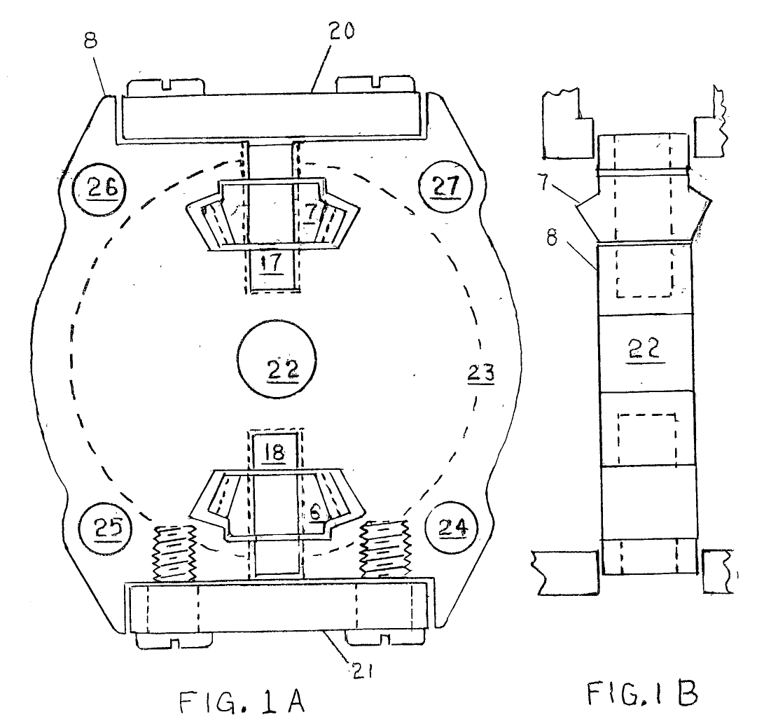

Drawing 1/5, FIG. 1, is a front view of a inline two cylinder engine to show the cutaway View A-A with the invenion gearbox shown installed between the two one cylinder engines. The gearbox is shown with hatching. The front engine, without hatching, is shown on the right side of the invention. The rear engine, also shown without hatching, is shown on the left side of the invention in less detail to reduce “clutter” of drawing. The gear pivot pins are shown in cross hatch. The front and rear engines are shown with crankcase rear closures removed, and replaced by the gear assembly of the invention, which now closes both engine crankcases and solidly holds both engines in place.

The output drive shaft, Ref. 1, crank pin, Ref. 2, is engaged with gearbox alignment pin, Ref. 3, the ring gear, Ref. 4, and ring gear mount, Ref 5, therefore these parts, Ref. 1 thru 5, will all rotate as one, in the same direction. The ring gear, Ref. 4 rotates both of the pinion gears, Ref. 6 and 7, which rotate in the fixed pinion gear mount, Ref. 8. bolted to the front and rear engine crankcases, Ref. 9 and 10. The rotation of the pinion gears will rotate the rear ring gear, Ref. 11, ring gear mount, Ref. 12, and rear alignment pin, Ref. 13. The rear alignment pin is engaged with rear engine crank pin and drive shaft which are rotated in the opposite direction of the front engine. The front and rear balance pins, Ref. 14 and 15, are used for alignment and balance of the ring gear assemblies, the ring gear pivot pin, Ref. 16, and upper and lower pinion gear pivot pins, Ref. 17 and 18, are used to hold all gears in proper alignment. The front engine connecting rod, Ref. 19, is shown for orientation.

Drawing 2/5, FIG. 1A, shows a cutaway view of the pinion gear mount, Ref. 8. Also shown are the pinion gears, Ref. 6 and 7, and pinion gear pivot pins, Ref. 17 and 18. The upper and lower pinion closure plates, Ref. 20 and 21, are used to facilitate assembly and retain the pivot pins. The hole in the center, Ref. 22, is for the ring gear pivot pin, FIG. 1, Ref. 16. The dash-line circle, Ref. 23, denotes the inside opening of the engine crankcase. The four outer holes, Ref. 24, 25, 26, and 27, align with four holes on the engine crankcase. Bolts are used in these holes to fasten the two engines and gearbox firmly together and prevent the pinion gear mount from rotating, FIG. 1B, edge view is shown for reference and clarity.

Drawing 3/5, FIG. 1C, is a cut a way view of the rear ring gear assembly, View B-B. The front ring gear assembly is identical to the rear in form and function. The ring gear mount, Ref. 12, is shown with the ring gear, Ref. 4, mounted inside. The ring gear is locked to the ring gear mount by the balance pin inserted into hole, Ref. 28, and gearbox alignment pin inserted into alignment pin hole, Ref. 29. The ring gear pivot pin is inserted into hole, Ref. 30. This is the pivot point around which the ring gear assemblies rotate. FIG. 1D, is the edge view of the ring gear mount, Ref. 12, and the ring gear, Ref. 4, and their relationship to the alignment holes, Ref. 28, 29, and 30.

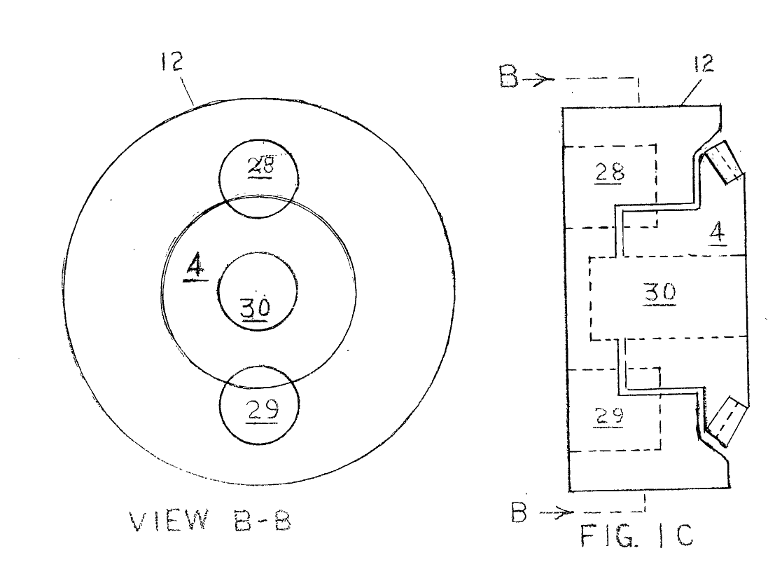

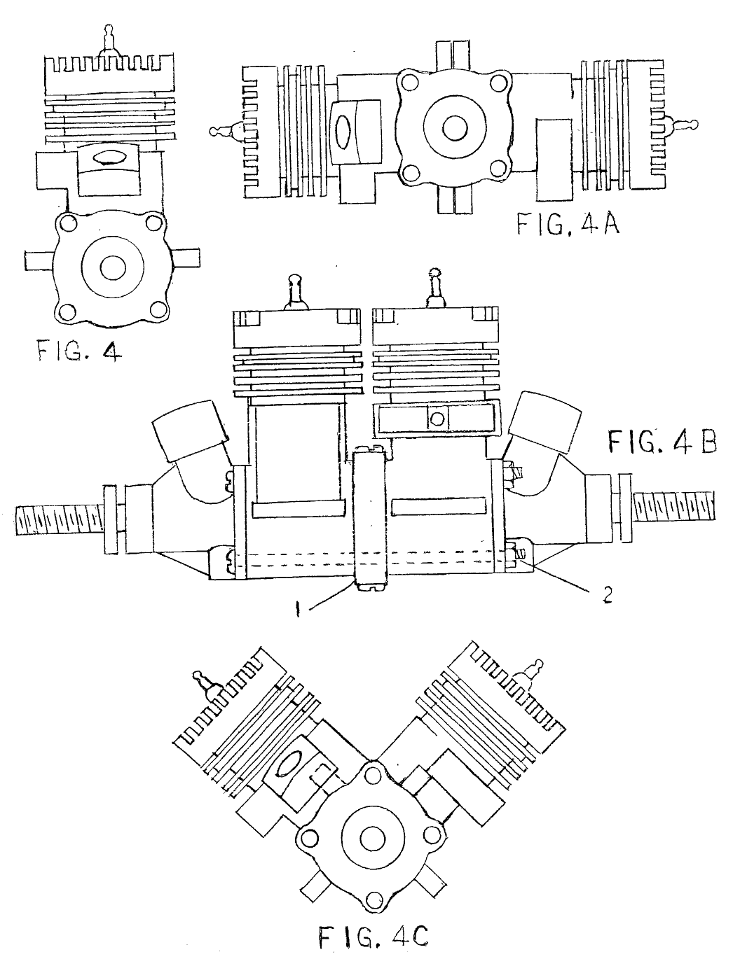

Drawing 4/5, FIG. 4, is a typical two-cycle gasoline engine. Two of this type were used as a prototype to test this invention. The two engines are joined back to back with the gearbox assembly, FIG. 4B, Ref. 1, located between the crankcases of the engines. This makes possible the variable geometry, such as: HORIZONTAL OPPOSED, FIG. 4A, two-cyclinder INLINE, FIG. 4B, or the V-2, FIG. 4C. The engine can be mounted for use by the mounting points on either side of the crankcase, or by the four bolts, Ref. 2, passing through both crankcases and holding entire assembly together. This assembly is for a three piece crankcase, both front and rear crankcase closures are removable from the main crankcase.

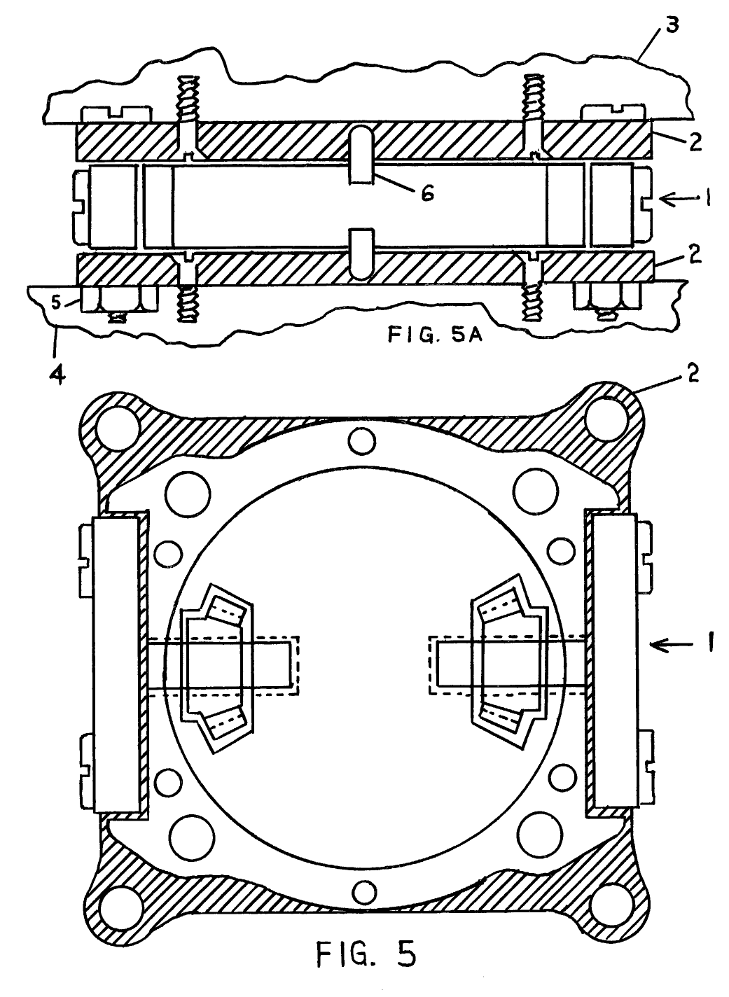

Drawing 5/5, FIG. 5, is a modified form of construction required for a two piece crankcase where only the rear closure can be removed to allow use of this invention, Ref. 1. This modification consists of two adapter plates, shown in hatching, Ref. 2, one plate is attached to the front engine, Ref. 3, the other to the rear engine, Ref. 4. The gearbox is installed between the adapter plates and secured with four bolts and nuts, Ref. 5, and alignment pins, Ref. 6. An additional modified form may be required to adapt this invention to a multicylinder Radial engine.

### DETAILED DESCRIPTION OF THE INVENTION

This invention consists of ring and pinion gear assemblies, the gear box is installed between two engines to cause the two engine crankshafts to rotate in opposite directions. How the gear is assembled and installed determines the geometry and the firing sequence of the cylinders.

The detailed function of the gearbox assembly, installed between two engines of two stroke design, is given in reference to Dwg, 1/5, View A-A.

When the forward engine drive shaft, Ref. 1, is turned counterclockwise, the crank pin, Ref. 2, which is engaged with gearbox alignment pin, Ref. 3, the ring gear, Ref. 4, and ring gear mount, Ref. 5, will also be rotated counterclockwise. The ring gear, Ref. 4, is engaged with both pinion gears, Ref. 6 and 7, which rotate within their shown position fixed, by the pinion gear mount, Ref. 8, which is bolted to the front engine crankcase housing, Ref. 9, and the rear engine crankcase housing, Ref. 10, thus the pinion gears, Ref. 6 and 7, will rotate in their respective directions and driving the rear ring gear, Ref. 11 and rear ring gear mount, Ref. 12. The rear gearbox alignment pin, Ref. 13, is engaged with the rear engine crank pin and rotates the rear engine drive shaft in the opposite direction of the front engine drive shaft, Ref. 1, viewed from the rear output shaft of the joined engines, the rear engine is rotating in the counterclockwise direction as designed. The front and rear balance pins, Ref. 14 and 15, are for alignment and balance of the ring gear mounts. The ring gear pivot pin, Ref. 16, with the upper and lower pinion gear pivot pins, Ref. 17 and 18, are used to hold all gears, with shims as required, in proper alignment. Engine connecting rod, Ref. 19, is shown for orientation. engine crankshaft, crankpin, counter weight and large portion of the connecting rod creates a rotational torque in direct relation to the mass and the rate of acceleration.

While spinning at a high rate, the mass will behave as a gyroscope, producing a torque by its gyroscopic action when a force is applied perpendicular to the axis of rotation. Both of these torques are reduced to near zero by the two crankshafts rotating in opposite directions.

The firing sequence of the two cylinders is changed before joining the two engines to the invented gear box, by aligning one of the engines crankshafts at top-dead-center and the other engine at bottom-dead-center, then aligning the ring gear alignment pin holes with the drive shaft pins and alignment pins of each engine and bolt entire assembly together.

The above procedure will cause the two cylinders to fire alternately, one power stroke for each 180 degrees rotation of the crankshaft.

By aligning both crankshafts and ring gear assemblies to the top-dead-center position, both will fire simultaneously producing one power stroke for each 360 degrees of crankshaft rotation. This is the fixed firing sequence of, current production two cylinder engines, due to the fact that both cylinders share a common crankcase.

The best mode of operation would be the alternate firing sequence, one stroke for each 180 degrees of rotation. This almost continuous power output, which results in a quieter, smooth running and idling engine, and also reduces the size and weight of the required muffler.

The variable geometry is accomplished by rotating the rear engine 90 or 180 degrees the front engine to create the three geometries shown on Drawing 4/5, FIG'S 4A, 4B, and 4C.

1: I claim as my invention, the gearbox, that joins two 2 cycle or 4 cycle engines to create, in a novel way: a two cylinder engine in three variations; Dwg. 4/5, FIG A, B and C, each with a smaller cross section, and frontal area, than is currently available as a single cylinder engine of equivalent power, which allows the user to change power source to fit the needs (rather than change the needs to fit a power source).

2: I claim as my invention, a gearbox that will cause the crankshafts of two engines, joined by the gearbox, to rotate in opposite directions, which is new and unique in eliminating:
a. internal rotational torque and
b. internal gyroscopic torque, thereby making a radio controlled craft easier and safer to use

3: I claim as my invention the gearbox in which the gear alignment can be changed to alter the firing sequence of the cylinders of the two engines, independent of geometry, resulting in:
a. smoother running engine,
b. lower RPM at idle speeds,
c. a quieter running engine, that can use a smaller, lighter weight, (required) muffler.

4: I claim as my invention a gearbox, when used to join to engines back to back, the rear engines drive shaft is available to use as a power-take-off (PTO) to power:
a. a fluid pump for: fuel, smoke, sprays,
b. an air pump for: engine supercharger, ducted-fan propulsion, hovercraft,
c. drive a magneto ignition system or a distributor of a conventional ignition system,
d. drive another propeller for push-pull configuration on top of craft.

5: I claim the use of my gear box invention will make the use of gas power portable handtools, like; chainsaws, weed trimmers and edge trimmers, less tiring and safer to use because of the smoother running engine and the elimination of the internal torque forces which could twist the power tool out of control and cause serious injury.

6: An engine starter can be added to the rear drive shaft, powered by a spring, electric motor, a new and unique CO2 cartridge, or a small gun cartridge, any of which will easily fit in the space behind the two joined engines.

7: A small, novel and new, electric generator driven by the rear engine drive shaft to charge the on board batteries for longer runs, and eliminate the long wait for a ground based auxiliary charger to bring the batteries back to full charge for another use.
